(19) United States
(12) Patent Application Publication
(10) Pub. No.: US 2026/0074460 A1
(43) Pub. Date: Mar. 12, 2026

(54) CONNECTOR

(71) Applicant: SUMITOMO WIRING SYSTEMS, LTD., Mie (JP)

(72) Inventors: Kazuo NAKAI, Mie (JP); Yukihiro FUKATSU, Mie (JP)

(21) Appl. No.: 19/108,439

(22) PCT Filed: Aug. 18, 2023
(86) PCT No.: PCT/JP2023/029902

§ 371 Date: Mar. 4, 2025

(30) Foreign Application Priority Data
Sep. 8, 2022 (JP) 2022-142802

(51) Int. Cl. H01R 13/52; H01R 13/506

(52) U.S. Cl. CPC H01R 13/5202; H01R 13/506; H01R 13/5213

(57) ABSTRACT

A connector includes a housing body, a fitting tube portion surrounding the housing body, a coupling portion coupling the housing body and the fitting tube portion, and a seal member mounted on a seal surface of the housing body. On the outer peripheral surface of the housing body, a protrusion is formed to protrude into a fitting space from a position in front of the seal surface. The coupling portion includes a first mold removal hole opening at a position opposing the rear surface of the protrusion, and a second mold removal hole opening side by side with the first mold removal hole in a rear view of the coupling portion and communicates with the first mold removal hole, the second mold removal hole having a step extending in a direction intersecting a direction in which the first mold removal hole and the second mold removal hole are

### Technical Field

The present disclosure relates to a connector.

### BACKGROUND

A connector disclosed in Patent Document 1 is provided with a connector housing. The connector housing includes a housing body (referred to as a “terminal housing portion” in Patent Document 1), a fitting tube portion surrounding the outer side of the housing body, and a coupling portion coupling the housing body and the fitting tube portion (the fitting tube portion and the coupling portion are collectively referred to as a “hood portion” in Patent Document 1). A hood of a partner connector is fitted into a space that is open between the housing body and the fitting tube portion and located forward of the coupling portion. A seal surface for attaching a seal ring is formed on an outer peripheral surface of the housing body. The seal ring is in close contact with the seal surface of the housing body and an inner peripheral surface of the hood of the partner connector.

A retaining protrusion protrudes from the outer peripheral surface of the housing body at a position that is forward of the seal surface. The retaining protrusion is disposed spaced apart from and forward of the coupling portion with the seal surface interposed therebetween. A rear surface (a surface facing rearward) of the retaining protrusion is molded by a mold that is pulled out rearward. A mold removal hole formed due to the removal of the mold is open (penetrates) at a position that opposes the rear surface of the retaining protrusion of the coupling portion.

Patent Document 2 discloses an outer protrusion that corresponds to the retaining protrusion and is formed on the outer peripheral surface of a front holder. In Patent Document 2, the outer protrusion is not formed on the connector housing, and thus the mold removal hole is not formed in the coupling portion. Patent Document 3 discloses a female protrusion that corresponds to the retaining protrusion.

### PRIOR ART DOCUMENT

### Patent Document

Patent Document 1: JP 2005-158396 A

Patent Document 2: JP 2008-016262 A

Patent Document 3: JP 2022-086057 A

### SUMMARY OF THE INVENTION

### Problems to be Solved

In the case of Patent Document 2, rattling between the front holder and the hood of the partner connector can be suppressed by distal end surfaces of the outer protrusions coming into contact with the hood of the partner connector. However, since a structure for suppressing rattling (see the inner protrusion of Patent Document 2) is also required between the front holder and the housing body, complicated setting needs to be performed to suppress rattling. Here, if the rattling prevention structure is not appropriately formed, the front holder may come off from the housing body when the connector is detached, and the front holder may remain inside the hood.

In view of this, according to Patent Document 1, the rattling between the connector housing and the hood can be suppressed by simply the retaining protrusion formed on the housing body, and the complexity of the above-described setting can be eliminated. However, in the case of Patent Document 1, the above-described mold has an axial length exceeding the length in the front-rear direction of the seal surface, and is shaped as a pin having a small diameter corresponding to the opening diameter of the mold removal hole. For this reason, when the connector housing is molded, there is a possibility that the mold will fall around the axis, and burrs or the like are generated on the seal surface due to the falling of the mold, which prevents the seal surface from being favorably formed.

In view of this, an object of the present disclosure is to provide a connector with which a favorable seal surface can be formed on a housing body.

### Means to Solve the Problem

A connector according to the present disclosure is a connector including: a housing body having a seal surface on an outer peripheral surface facing an outer side; a fitting tube portion surrounding the outer side of the housing body; a coupling portion coupling the housing body and the fitting tube portion; and a seal member mounted on the seal surface of the housing body, and a fitting space is open between the housing body and the fitting tube portion and forward of the coupling portion, a hood of a partner connector is fitted into the fitting space, and the seal member is disposed in close contact with an inner peripheral surface of the hood and the seal surface of the housing body, the housing body includes a protrusion protruding on the outer peripheral surface from a position forward of the seal surface into the fitting space, and the coupling portion includes a first mold removal hole that is open at a position opposing a rear surface of the protrusion, and a second mold removal hole that is in communication with the first mold removal hole and, in a rear view of the coupling portion, is open side by side with the first mold removal hole and has a step extending in a direction intersecting a direction in which the first mold removal hole and the second mold removal hole are side by side.

### Effect of the Invention

According to the present disclosure, it is possible to provide a connector with which a favorable seal surface can be formed on a housing body.

### BRIEF DESCRIPTION OF THE DRAWINGS

FIG. 1 is a rear view of a connector according to a first embodiment of the present disclosure.

FIG. 2 is a cross-sectional view taken along line A-A in FIG. 1.

FIG. 3 is a perspective view of the connector according to the first embodiment, with a portion cut out.

FIG. 4 is a front view of a connector housing of the connector according to the first embodiment.

FIG. 5 is a rear view of the connector housing of the connector according to the first embodiment.

FIG. 6 is a plan view of the connector housing of the connector according to the first embodiment.

FIG. 7 is an enlarged cross-sectional view showing a state in which a mold and a partner mold of the connector according to the first embodiment are combined with each other.

FIG. 8 is a cross-sectional view, corresponding to FIG. 2, of a connector according to a second embodiment of the present disclosure before fitting.

FIG. 9 is a front view of a connector housing of the connector according to the second embodiment.

FIG. 10 is a rear view of the connector housing of the connector according to the second embodiment.

FIG. 11 is a plan view of the connector housing of the connector according to the second embodiment.

FIG. 12 is a partially broken enlarged plan view showing a state in which a slide mold and a partner mold have been combined with each other in manufacturing the connector according to the second embodiment.

FIG. 13 is an enlarged plan view showing a state in which the partner mold is moving forward after the slide mold is pulled out from the state shown in FIG. 12.

FIG. 14 is an enlarged plan view showing a state in which the partner mold is pulled out from the state shown in FIG. 13.

FIG. 15 is a cross-sectional view, corresponding to FIG. 2, of a connector according to a third embodiment of the present disclosure, with a wire cover added.

FIG. 16 is a diagram corresponding to FIG. 7 of a reference example.

### DETAILED DESCRIPTION TO EXECUTE THE INVENTION

### Description of Embodiments of the Present Disclosure

First, embodiments of the present disclosure will be listed and described.
(1) A connector according to the present disclosure includes: a housing body having a seal surface on an outer peripheral surface facing an outer side; a fitting tube portion surrounding the outer side of the housing body; a coupling portion coupling the housing body and the fitting tube portion; and a seal member mounted on the seal surface of the housing body, and a fitting space is open between the housing body and the fitting tube portion and forward of the coupling portion, a hood of a partner connector is fitted into the fitting space, and the seal member is disposed in close contact with an inner peripheral surface of the hood and the seal surface of the housing body, the housing body includes a protrusion protruding on the outer peripheral surface from a position forward of the seal surface into the fitting space, and the coupling portion includes a first mold removal hole that is open at a position opposing a rear surface of the protrusion, and a second mold removal hole that is in communication with the first mold removal hole and, in a rear view of the coupling portion, is open side by side with the first mold removal hole and has a step extending in a direction intersecting a direction in which the first mold removal hole and the second mold removal hole are side by side.

The rear surface of the protrusion is formed by pulling out rearward a mold having a molding surface corresponding to the rear surface of the protrusion. The mold needs to have an axial length that exceeds the length in the front-rear direction of the seal surface. In the case of this configuration, since the mold has the opening cross-section of the continuous mold removal hole formed by the first mold removal hole and the second mold removal hole, the mold has a large diameter, and a predetermined rigidity is easily secured. In addition, since the second mold removal hole has a step relative to the first mold removal hole and is in communication with the second mold removal hole, a step corresponding to this step is also formed in the mold. Therefore, a stepped portion including the step of the mold can be combined with the partner mold for molding a front surface of the coupling portion in a key shape (concavo-convex shape), and a situation in which the mold falls during molding can be prevented. As a result, the formation of burrs or the like on the seal surface after molding can be suppressed, and a favorable seal surface can be formed on the housing body.
(2) It is preferable that the first mold removal hole and the second mold removal hole each have a T-shape or an L-shape in the rear view of the coupling portion.

According to the above configuration, since the mold for molding the rear surface of the protrusion has a T-shaped or L-shaped cross-sectional shape, the mold can be stably combined with the partner mold in a key shape, and the falling of the mold can be more reliably prevented.
(3) It is preferable that the housing body is provided with a cavity for accommodating a terminal fitting, a pair of the first mold removal hole and the second mold removal hole is provided at left and right positions and at least one of upper and lower positions, with the cavity interposed therebetween in the rear view of the coupling portion, the second mold removal hole disposed at at least one of the upper and lower positions includes the step extending in a left-right direction, and the second mold removal hole is disposed at the left and right positions includes the step extending in an up-down direction.

With the above configuration, the mold for molding the rear surface of the protrusion and the partner mold can be combined with each other vertically and horizontally in a complicated manner, making it possible to more reliably prevent the falling of the mold.
(4) It is preferable that a wire cover for covering a wire drawn out rearward from the housing body is mounted on the housing body, and the wire cover has a positioning portion to be fitted into at least one of the first mold removal hole and the second mold removal hole.

With the above configuration, since the wire cover can be positioned using at least one of the first mold removal hole and the second mold removal hole, it is not necessary to form a dedicated positioning hole or the like for positioning the wire cover in the coupling portion or the like, and the configuration of the connector can be simplified.

### Detail of Embodiments of Present Disclosure

Specific examples of embodiments of the present disclosure will be described below with reference to the drawings. Note that the present invention is not limited to these examples, but rather is indicated by the claims, and is intended to include all modifications within the scope and meaning equivalent to the claims.

### First Embodiment

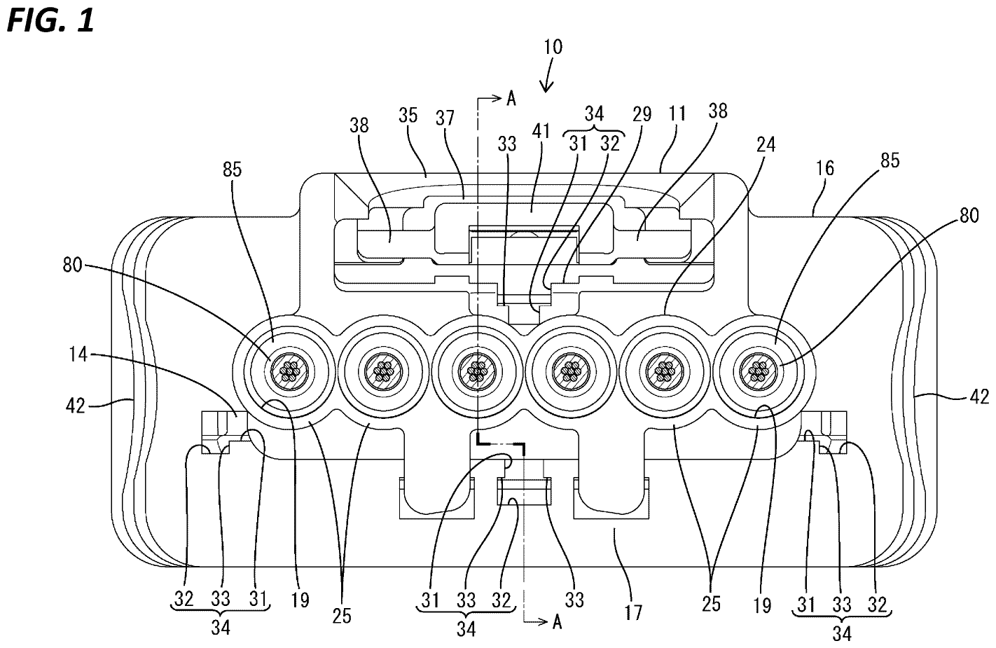

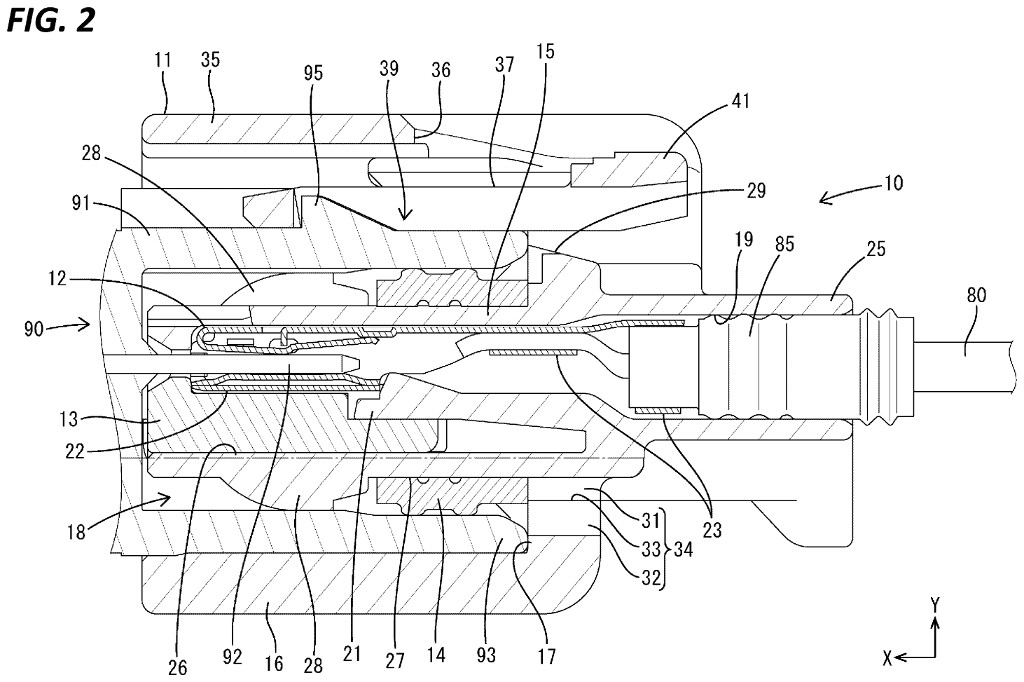

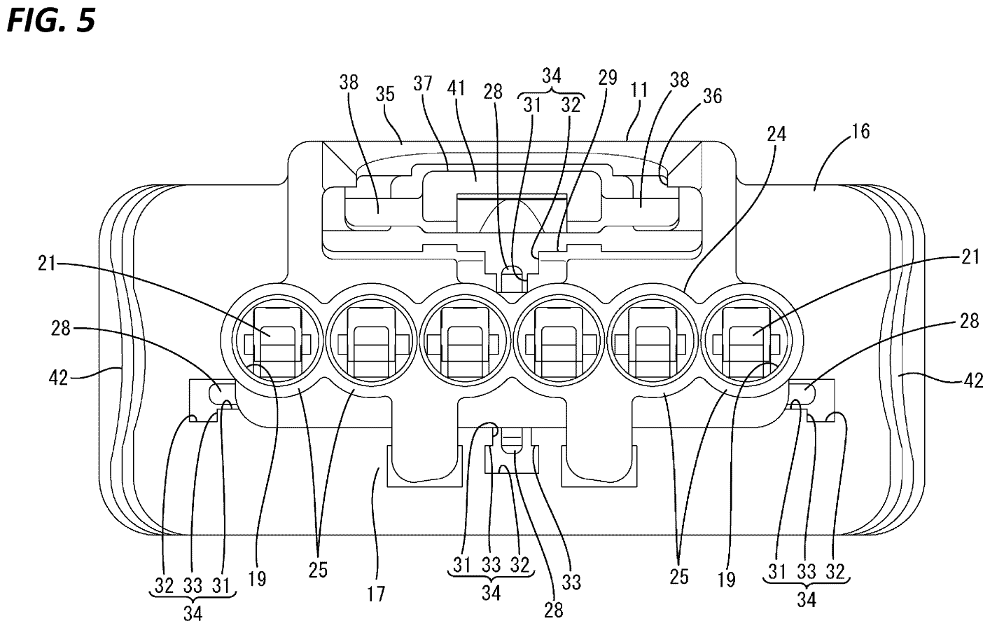

A connector 10 according to a first embodiment of the present disclosure is a waterproof connector and includes a connector housing 11, terminal fittings 12, a retainer 13, and a seal member 14, as shown in FIG. 2. The connector housing 11 is configured to fit to a partner connector housing 91 of a partner connector 90. In the following description, surfaces of the connector housing 11 and the partner connector housing 91 facing each other at the start of fitting are referred to as front sides in a front-rear direction. The left side in FIG. 2 is the front side of the connector 10. The front side of the partner connector 90 is the right side in FIG. 2. The up-down direction is based on the up-down direction in the drawings except FIG. 5. The left-right direction is based on the left-right direction in FIG. 1. Arrows X and Y in FIG. 2 respectively indicate a “front side” and an “upper side” of the connector 10. The references of the directions are for convenience, and do not necessarily coincide with the references of the directions in a state where the connector 10 and the partner connector 90 are mounted in a vehicle or the like (not shown).

### (Partner Connector)

As shown in FIG. 2, the partner connector 90 includes the partner connector housing 91 and a plurality of partner terminal fittings 92. The partner connector housing 91 is made of synthetic resin and includes a hood 93 that is flattened in the left-right direction although not shown in detail. The hood 93 has a tubular shape and is open forward. The partner terminal fittings 92 are made of conductive metal, are pin-shaped, and are arranged in a row in the lateral direction and project into the hood 93. A lock portion 95 protrudes on the upper surface of the upper wall of the hood 93.

### (Connector)

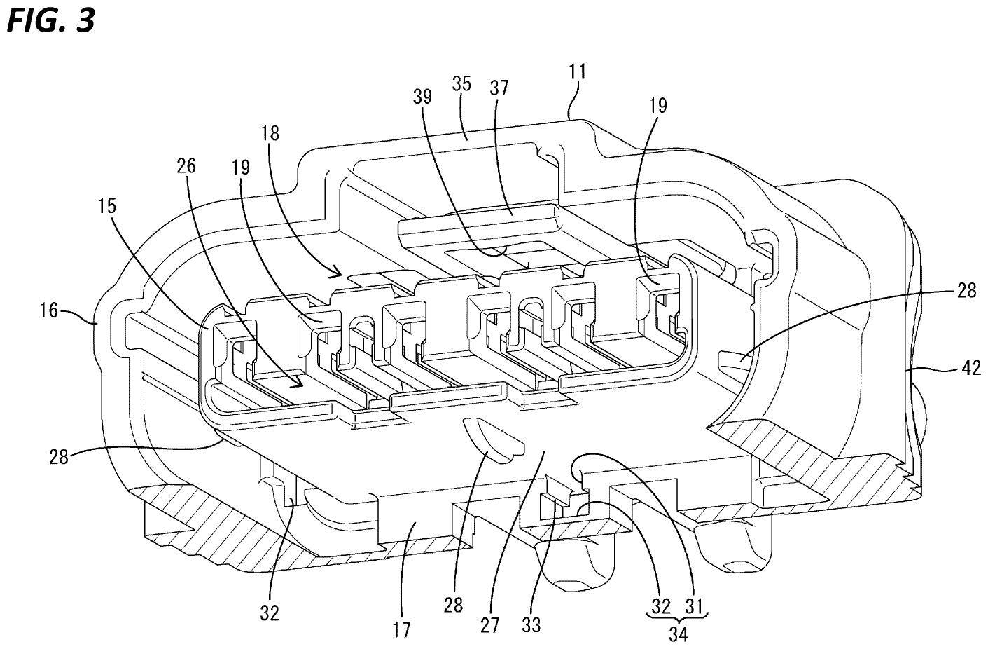

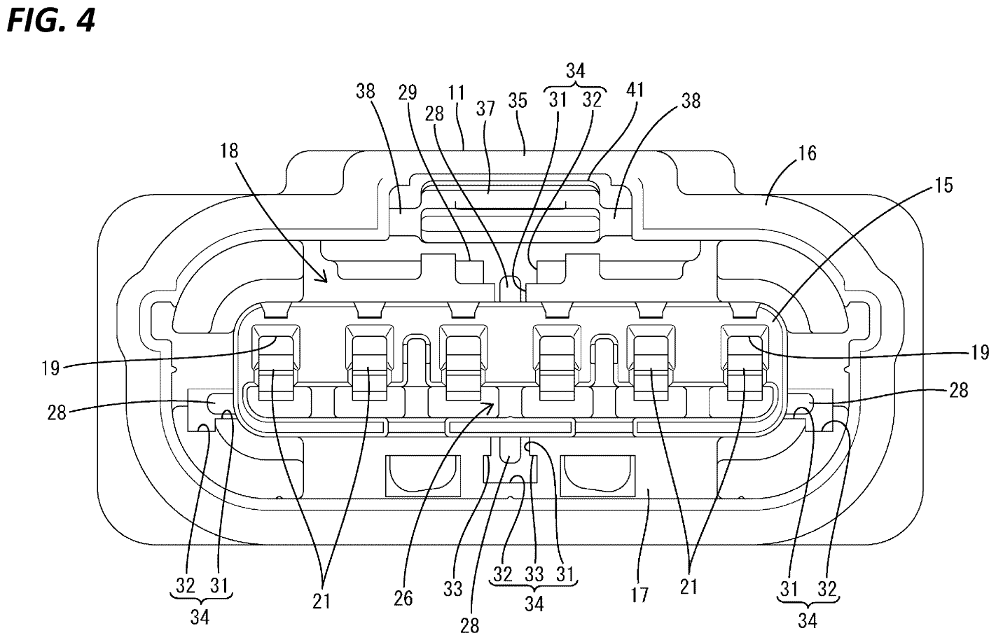

The connector housing 11 is made of synthetic resin and, as shown in FIGS. 3 and 4, integrally includes a housing body 15 that is flattened in the lateral direction, a fitting tube portion 16 that surrounds the outside of the housing body 15, and a coupling portion 17 that couples the housing body 15 and the fitting tube portion 16 in the radial direction. As shown in FIG. 2, a space located between the housing body 15 and the fitting tube portion 16 and is open forward of the coupling portion 17 serves as a fitting space 18 into which the hood 93 of the partner connector 90 can be fitted.

As shown in FIGS. 3 to 5, a plurality of cavities 19 are formed in the housing body 15. The cavities 19 are arranged in a row in the lateral direction to correspond to the partner terminal fittings 92 in the housing body 15. As shown in FIGS. 4 and 5, a lance 21 protrudes from a lower surface of an inner wall of each cavity 19. Terminal fittings 12 are inserted into the respective cavities 19 of the housing body 15 from behind.

Each terminal fitting 12 is made of conductive metal and is integrally formed by bending a plate material, for example. As shown in FIG. 2, each terminal fitting 12 includes, at the front end portion thereof, a tubular connection portion 22 into which the partner terminal fitting 92 is to be inserted and connected, and at the rear end portion thereof, a barrel portion 23 to be connected to an end portion of a wire 80 by crimping. Each connecting portion 22 is locked by the lance 21. The terminal fittings 12 are primarily restricted from coming out from the housing body 15 by the lances 21.

The wires 80 are drawn out rearward from the housing body 15. A rubber plug 85 is fitted to an end portion of each wire 80. Each rubber plug 85 is coupled to the terminal fitting 12 by the barrel portion 23. Each rubber plug 85 is inserted into the cavity 19 together with the terminal fitting 12.

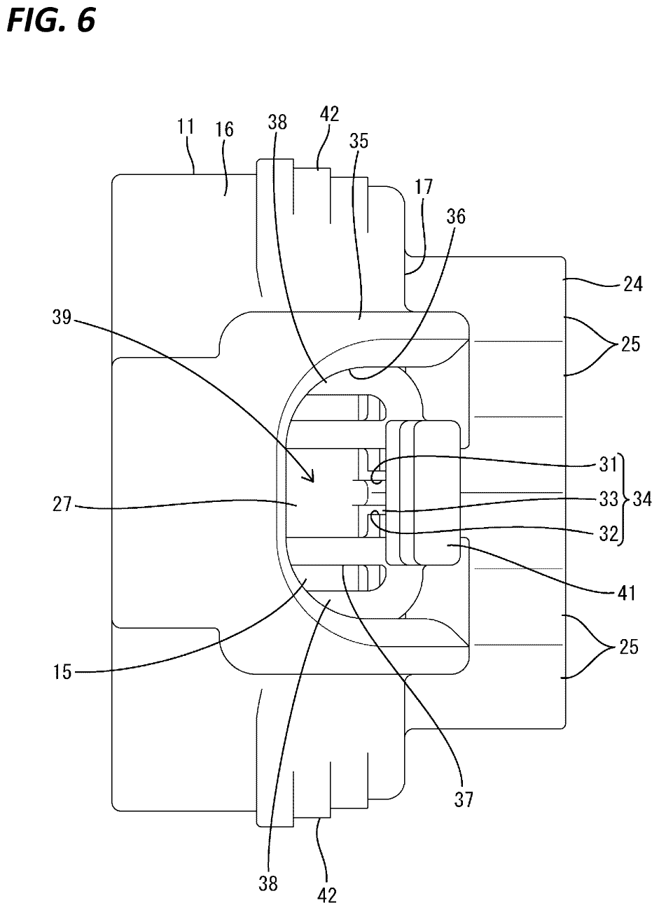

As shown in FIGS. 5 and 6, the connector housing 11 includes a continuous tube portion 24 projecting rearward from the coupling portion 17. The continuous tube portion 24 has a shape in which a plurality of cylindrical portions 25 are connected in the left-right direction. The inside of each cylindrical portion 25 forms a rear portion of the cavity 19. As shown in FIGS. 1 and 2, the rubber plugs 85 are in close contact with the inner peripheral surfaces of the cylindrical portions 25 to seal the inside of the housing body 15 in a liquid-tight manner.

As shown in FIGS. 3 and 4, retainer insertion holes 26 are open in the front surface of the housing body 15. Each retainer insertion holes 26 has a laterally elongated opening shape in the front surface of the housing body 15 and communicates with the corresponding cavity 19 from below. Each lance 21 is arranged to be exposed in the corresponding retainer insertion hole 26. As shown in FIG. 2, the retainers 13 are inserted into the retainer insertion holes 26 of the housing body 15 from the front.

The retainers 13 are made of synthetic resin and, although not shown in detail, have a flat plate shape that is rectangular in plan view as a whole. The rear portion of each retainer 13 enters below the lance 21 to prevent flexing of the lance 21. The retainers 13 secondarily prevent the terminal fittings 12 from coming out from the connector housing 11.

As shown in FIG. 3, a flat seal surface 27 is formed entirely around the outer peripheral surface (surface that faces outward and the fitting space 18) of the housing body 15. On the outer peripheral surface of the housing body 15, the seal surface 27 extends in a front-rear range from a position continuous with the coupling portion 17 to a rear surface of each protrusion 28 (described later). As shown in FIG. 2, the seal member 14 is fitted to the seal surface 27 of the housing body 15 from the front. The seal member 14 is made of rubber such as silicon rubber, has an annular shape, and has a constant dimension in the front-rear direction. Although not shown in detail, the seal member 14 is formed in a horizontally-long annular shape that is elongated in the left-right direction and has rounded corners. The inner peripheral surface of the seal member 14 is in close contact with the outer peripheral surface of the housing body 15, and the outer peripheral surface of the seal member 14 is in close contact with the inner peripheral surface of the hood 93, so that the connector housing 11 and the partner connector housing 91 are sealed in a liquid-tight manner.

As shown in FIG. 3, a plurality of protrusions 28 are formed on the outer peripheral surface of the housing body 15 at positions opposite to the coupling portion 17 across the seal surface 27 in the front-rear direction. The protrusions 28 have a shape extending in the front-rear direction in a rib-like manner, and protrude toward the fitting space 18. As shown in FIG. 4, the protrusions 28 are disposed at laterally intermediate portions of the upper and lower surfaces of the housing body 15 and below vertically intermediate portions of the left and right surfaces of the housing body 15. In short, the protrusions 28 are arranged at intervals in the vertical and horizontal directions on the outer peripheral surface of the housing body 15. As shown in FIGS. 2 and 3, each protrusion 28 bulges in a curved manner from the front end to the distal end surface in the protruding direction. As shown in FIG. 2, the distal end surface of each protrusion 28 in the protruding direction is disposed so as to come into contact with the inner peripheral surface of the hood 93 when the connector housing 11 and the partner connector housing 91 are fitted to each other. The connector housing 11 and the partner connector housing 91 are maintained in a state in which rattling is suppressed by the protrusions 28.

As shown in FIG. 2, the rear surface of each protrusion 28 extends along the up-down direction and closely opposes the front surface of the seal member 14. The sealing member 14 is restricted from coming off backward from the connector housing 11 by the coupling portion 17, and is restricted from coming off forward from the connector housing 11 by the protrusions 28.

In this way, each protrusion 28 has both a function of suppressing rattling between the connector housing 11 and the partner connector housing 91 and a function of restricting the seal member 14 from coming off forward.

The coupling portion 17 has a wall shape extending along the radial direction, and is disposed with the wall surfaces facing in the front-rear direction. As shown in FIGS. 4 and 5, the coupling portion 17 is spaced apart from the fitting tube portion 16 at a position corresponding to a lower side of a lock arm 37 described later, and has an upper end surface 29 facing the lock arm 37 from below. In the coupling portion 17, a plurality of first mold removal holes 31 are open (penetrate) at positions that opposes the rear surfaces of the protrusions 28 in the front-rear direction. As shown in FIG. 5, the rear surfaces of the protrusions 28 are visible from behind through the first mold removal holes 31.

As shown in FIG. 5, among the first mold removal holes 31, the first mold removal hole 31 located on the lower side in a rear view is open in a rectangular shape in a rear view at a position below a laterally intermediate portion of the continuous tube portion 24 and away from the continuous tube portion 24. The first mold removal hole 31 located on the upper side in a rear view is open in a rectangular shape in a rear view at a position above a laterally intermediate portion of the continuous tube portion 24 and close to the continuous tube portion 24. The first mold removal holes 31 located on both left and right sides in a rear view are open in a rectangular shape in a rear view at a position on a lateral side of a lower portion of the continuous tube portion 24 and close to the continuous tube portion 24. In short, the respective first mold removal holes 31 are disposed oppositely at upper and lower positions and left and right positions sandwiching the continuous tube portion 24 in the coupling portion 17.

As shown in FIG. 2, in a state where the seal member 14 is mounted on the seal surface 27 of the housing body 15, the front of each first mold removal hole 31 is closed by the seal member 14, and the protrusions 28 are hidden by the seal member 14 and cannot be seen from the first mold removal holes 31.

Further, as shown in FIGS. 4 and 5, a plurality of second mold removal holes 32 communicating with the respective first mold removal holes 31 side by side are open on the outside of the respective first mold removal holes 31 in the coupling portion 17. Each of the second mold removal holes 32 has a shoulder-shaped step 33 extending in a direction intersecting the arrangement direction of the first mold removal holes 31 with which the second mold removal holes 32 communicate, and has a shape wider than the first mold removal holes 31 in the extending direction of the steps 33. As shown in FIG. 5, among the second mold removal holes 32, the second mold removal holes 32 communicating with the first mold removal holes 31 on both upper and lower sides have steps 33 extending in the left-right direction orthogonal to the left and right edges (side edges) of the first mold removal holes 31, and protrude to both left and right sides with respect to the first mold removal holes 31, thereby forming a T-shaped opening shape in a rear view together with the first mold removal holes 31.

The second mold removal hole 32 on the upper side is open in the upper end surface 29 of the coupling portion 17 on the side opposite to the side communicating with the first mold removal hole 31. Each of the second mold removal holes 32 communicating with the first mold removal holes 31 on both left and right sides has a step 33 extending downward of the first mold removal hole 31, and widens below the first mold removal hole 31, thereby forming an L-shaped opening shape in a rear view together with the first mold removal hole 31. The range in which each protrusion 28 projects to the coupling portion 17 side is included in each first mold removal hole 31, but is not included in each second mold removal hole 32, or is partially included in each second mold removal hole 32. In the following description, the overall hole formed by the first mold removal hole 31 and the second mold removal hole 32 having a T-shape or an L-shape in a rear view will be referred to as a “continuous mold removal hole 34”. As shown in FIG. 4, the continuous mold removal hole 34 is visible together with the front surfaces of the protrusions 28 when viewed from the front of the connector housing 11.

As shown in FIGS. 3 to 6, the fitting tube portion 16 has a protection wall 35 bulging upward at a laterally intermediate portion of the upper wall. As shown in FIG. 6, a recess 36 is formed in the protection wall 35 by cutting out the rear end of the protection wall 35. The lock arm 37 is disposed inside the protection wall 35. The lock arm 37 is elastically deformable in the up-down direction with a pair of arm portions 38 connected to the inner surface of the protection wall 35 as fulcrums. A lock hole 39 extends through the lock arm 37 in the up-down direction. As shown in FIG. 2, when the lock portion 95 is fitted into the lock hole 39 of the lock arm 37, the connector housing 11 and the partner connector housing 91 are held in a fitted state. At the rear end of the lock arm 37, a release operation portion 41 is formed one level higher. As shown in FIG. 6, the release operation portion 41 is visible from above through the recess 36. The upper continuous mold removal hole 34 is visible from above through the inside of the recess 36 and the lock hole 39 of the lock arm 37. When the release operation portion 41 is pressed from above and the rear end portion of the lock arm 37 is elastically deformed downward, the locked state between the lock arm 37 and the lock portion 95 is released, and the connector housing 11 and the partner connector housing 91 in the fitted state become capable of being separated from each other. As shown in FIG. 6, the fitting tube portion 16 has, on the respective left and right side wall portions, slip prevention portions 42 that expand in a step-like manner from positions continuous with the coupling portion 17 toward the front. An operator can perform a fitting and detaching operation of the connector housing 11 and the partner connector housing 91 by putting the fingers on the left and right slip prevention portions 42.

### (Operation of Connector)

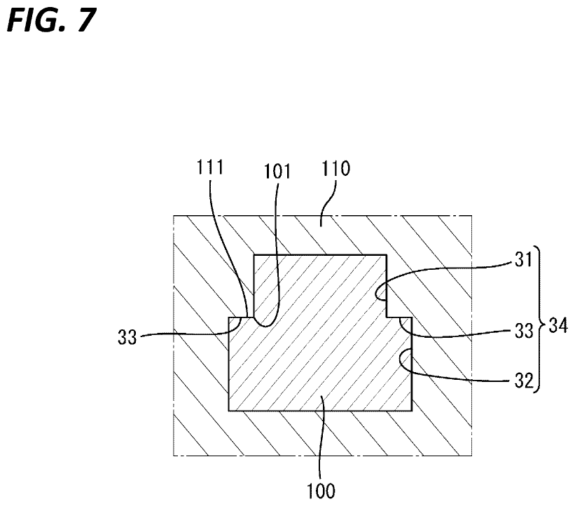

When the connector housing 11 is molded, although not shown in detail, a partner mold 110 that is pulled out forward to mold the fitting space 18 and the front surfaces of the protrusions 28 and a mold 100 that is pulled out rearward to mold the rear surfaces of the protrusions 28 are used (see FIG. 7). The partner mold 110 and the mold 100 are combined so as to be slidable in the front-rear direction in which they are separated from each other. In short, the partner mold 110 and the mold 100 are combined with each other, a space formed inside is filled with a resin in a molten state, and after the resin is cured, the partner mold 110 and the mold 100 are moved (opened) in the above-described pull-out direction, whereby the connector housing 11 is molded.

The mold 100 forms the continuous mold removal holes 34 in the coupling portion 17 by being pulled out rearward. As shown in FIG. 16 as a reference example, since a normal mold 100E has a pin shape with an axial length exceeding the front-rear length of the seal surface 27 (a shape in which the mold 100E is elongated in the thickness direction of the paper surface of FIG. 16), it is difficult to secure rigidity, and there is a concern that the mold 100E may fall around the shaft in a gap range with a partner mold 110E. If the mold 100E falls, burrs or the like are formed on the seal surface 27 of the housing body 15, which may prevent a smooth favorable seal surface 27 from being formed.

However, in the case of the first embodiment, the mold 100 has a T-shaped cross-sectional shape (see FIG. 7) or an L-shaped cross-sectional shape corresponding to the opening cross-section of the continuous mold removal hole 34. Therefore, the mold 100 itself can have rigidity. In addition, a stepped recess 101 including a step corresponding to the step 33 of the second mold removal hole 32 is formed in the mold 100, and a stepped protrusion 111 corresponding to the stepped recess 101 is formed in the partner mold 110. Therefore, when the mold 100 and the partner mold 110 are combined with each other, the stepped recess 101 and the stepped protrusion 111 can be engaged with each other in a key shape (concavo-convex shape). Therefore, a relative positional deviation between the mold 100 and the partner mold 110 is regulated, which prevents falling of the mold 100. As a result, in contrast to the reference example of FIG. 16, in the first embodiment shown in FIG. 7, an appropriate moving operation of the mold 100 and the partner mold 110 can be ensured, and a smooth and favorable seal surface 27 can be formed on the outer peripheral surface of the housing body 15.

In particular, in the case of the first embodiment, since the continuous mold removal hole 34 has a T-shaped or L-shaped opening shape in a rear view, the mold 100 can be stably combined with the partner mold 110 in a key shape, which can reliably prevent the mold 100 from falling.

Also, in the first embodiment, the plurality of continuous mold removal holes 34 are formed in the coupling portion 17. As shown in FIG. 5, the continuous mold removal holes 34 are respectively disposed at upper and lower positions and left and right positions sandwiching the continuous tube portion 24 in the coupling portion 17, and the continuous mold removal holes 34 on both upper and lower sides have steps 33 extending in the left-right direction, and the continuous mold removal holes 34 on the left and right sides have steps 33 extending in the up-down direction. For this reason, the stepped recess 101 of the mold 100 and the stepped protrusion 111 of the partner mold 110 can be complicatedly engaged with each other, which can more reliably prevent the falling of the mold 100.

### Second Embodiment

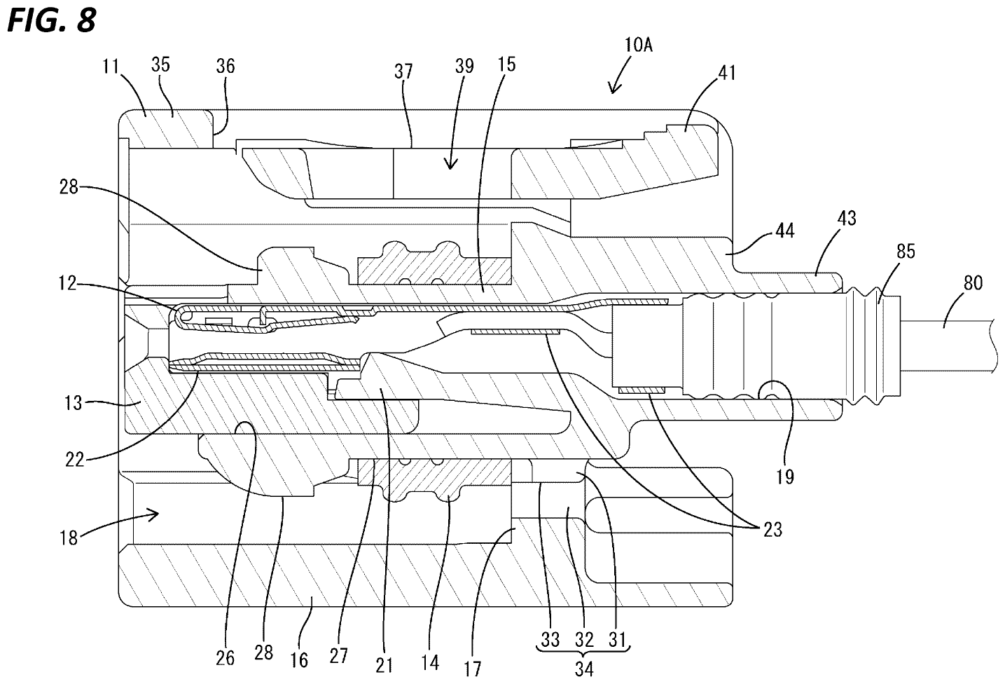

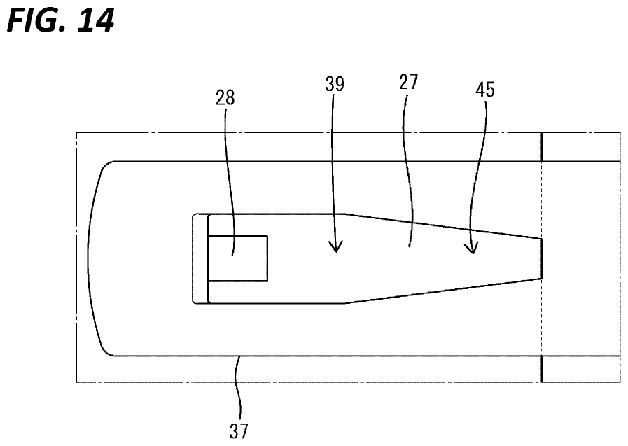

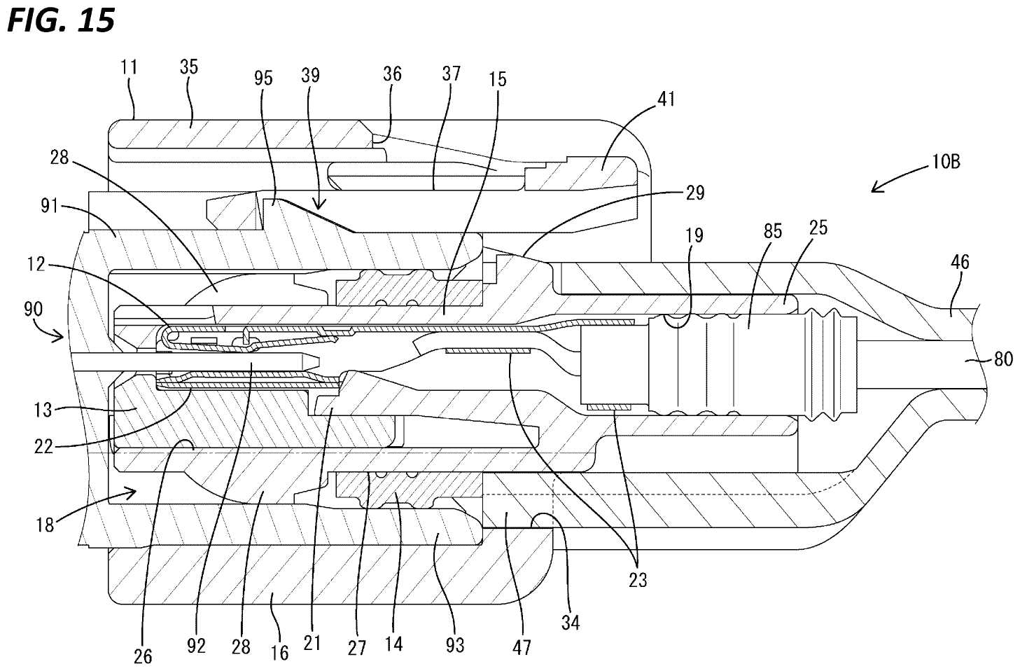

A second embodiment of the present disclosure is shown in FIGS. 8 to 14. A connector 10A according to the second embodiment of the present disclosure is a single-pole connector having one cavity 19, and is different from the connector 10 of the first embodiment which is a multi-pole connector. Note that in the following description, portions similar to those of the first embodiment will be denoted by the same reference signs as in the first embodiment.

As shown in FIG. 8, the connector 10A includes the connector housing 11, terminal fittings 12, the retainer 13, and the seal member 14. The connector housing 11 includes the housing body 15, the fitting tube portion 16 surrounding the outside of the housing body 15, and the coupling portion 17 connecting the housing body 15 and the fitting tube portion 16 in the radial direction. The fitting space 18 into which the hood 93 of the partner connector 90 can be fitted is formed between the housing body 15 and the fitting tube portion 16 and in front of the coupling portion 17. The terminal fitting 12 is inserted into the cavity 19 formed in the housing body 15 and locked by the lance 21, so that the terminal fitting 12 is primarily restricted from coming out from the housing body 15. Further, the retainer 13 mounted in the housing body 15 prevents flexing of the lances 21, so that the terminal fittings 12 are secondarily prevented from coming out from the housing body 15. The seal member 14 is attached to the seal surface 27 of the housing body 15. The plurality of first mold removal holes 31 and the plurality of second mold removal holes 32 (continuous mold removal holes 34) are open in (penetrate) the coupling portion 17. As described above, the basic configuration of the connector 10A is the same as that of the connector 10 of the first embodiment.

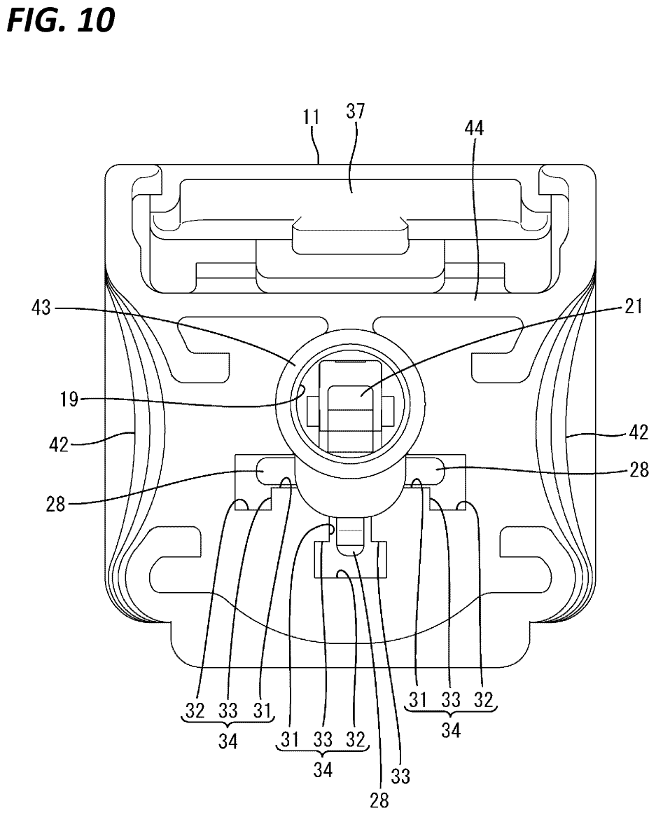

As shown in FIG. 10, the housing body 15 has one cylindrical tube portion 43 protruding rearward from the coupling portion 17. The tube portion 43 has one cavity 19 therein. In the coupling portion 17, the continuous mold removal holes 34 are arranged in pairs at positions on the left and right sides sandwiching the tube portion 43, and are arranged at positions on the lower side of both upper and lower sides sandwiching the tube portion 43, and are not arranged at positions on the upper side. An upper end of the tube portion 43 is coupled to a projecting wall 44 projecting rearward from an upper end of the coupling portion 17.

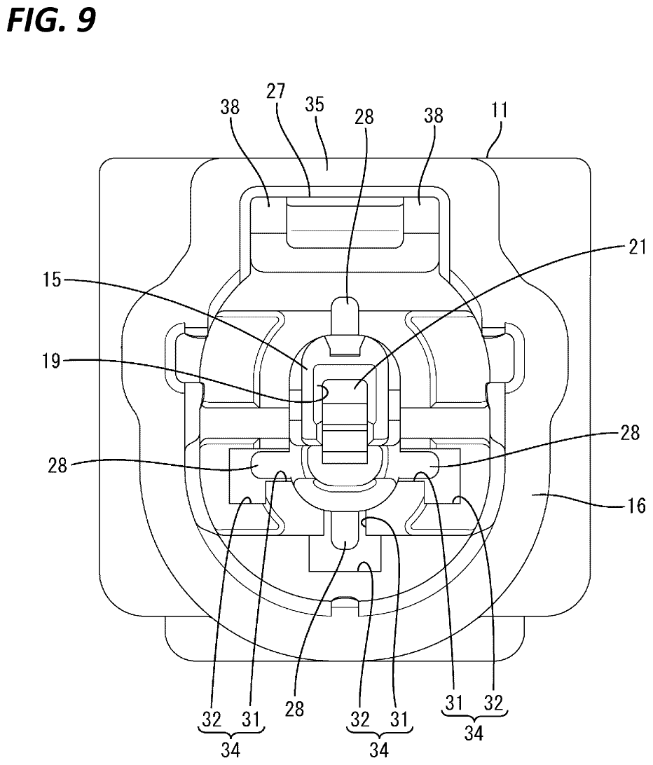

As shown in FIG. 9, on the outer peripheral surface of the housing body 15, the rib-shaped protrusions 28 protrude at upper, lower, left, and right positions at intervals in the circumferential direction, as in the first embodiment. As shown in FIG. 10, the protrusions 28 located on the left and right sides and on the lower side are disposed so as to be visible from behind through the corresponding continuous mold removal holes 34. In other words, the continuous mold removal holes 34 are formed in the coupling portion 17 at positions opposing the rear surfaces of the protrusions 28 located on the left and right sides and the lower side. The protrusion 28 located on the upper side is closed by the coupling portion 17 and cannot be visually recognized from behind. As will be described later, the rear surface of the protrusion 28 located on the upper side is molded by a slide mold 120 for forming the lock hole 39 of the lock arm 37.

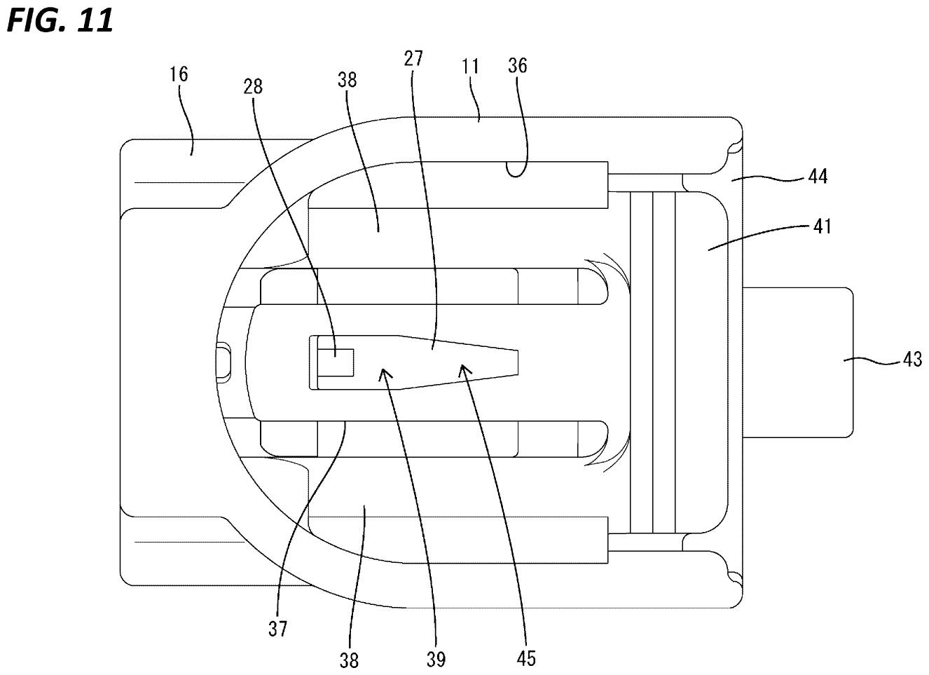

As shown in FIG. 11, the lock hole 39 of the lock arm 37 has a narrow space 45 tapered rearward at a rear portion of a rectangular opening portion that is elongated in the front-rear direction in plan view. In a state where the seal member 14 is not attached to the housing body 15, the lock hole 39 is open upward of the seal surface 27.

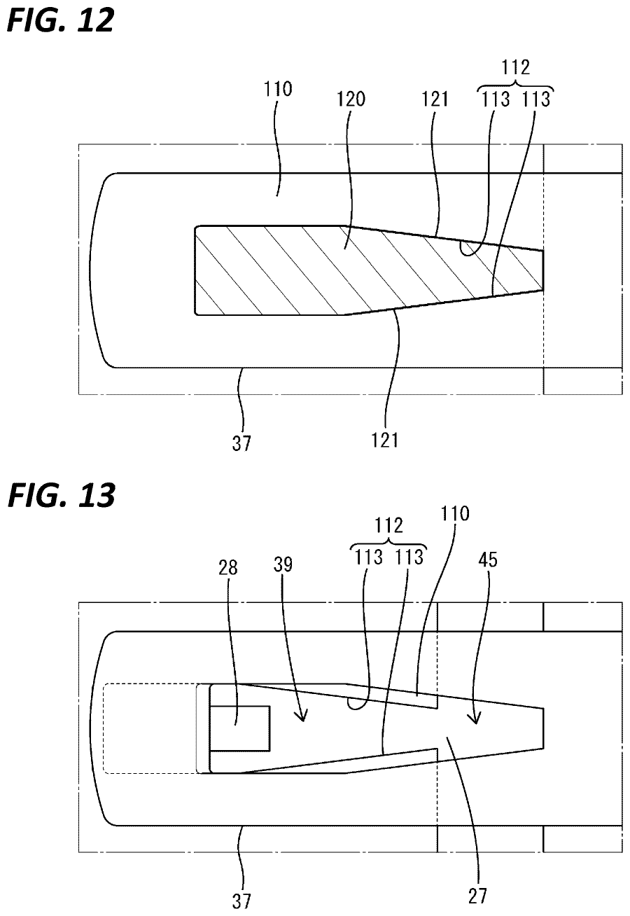

In the case of the second embodiment, when molding the connector housing 11, although not shown in detail, the partner mold 110 for molding the fitting space 18 and the front surfaces of the protrusions 28, a mold for molding the left and right sides and the rear surface of each protrusion 28 located on the lower side (although not shown in the second embodiment, a mold similar to the mold 100 of the first embodiment, hereinafter simply referred to as a “mold”), and a slide mold 120 for molding the rear surface of the protrusion 28 located on the upper side and the lock hole 39 of the lock arm 37 are used (see FIG. 12). Similarly to the first embodiment, the partner mold 110 and the mold are combined so as to be slidable in the front-rear direction in which they are separated from each other. On the other hand, the partner mold 110 and the slide mold 120 are combined so as to be slidable in directions orthogonal to each other (forward direction and upward direction).

Specifically, the partner mold 110, the aforementioned mold, and the slide mold 120 are combined with each other, and a space formed inside is filled with a resin in a molten state. After the resin is cured, first, the mold is pulled out rearward relative to the partner mold 110. At this time, as in the first embodiment, since the mold has a T-shaped or L-shaped cross-sectional shape corresponding to the opening cross-section of the continuous mold removal holes 34, the mold can be prevented from falling.

Subsequently, the slide mold 120 is pulled out upward relative to the partner mold 110. As shown in FIG. 12, the slide mold 120 has a cross-sectional shape corresponding to the opening cross-section of the lock hole 39, and has a tapered narrow portion 121 corresponding to the narrow space 45 in the rear portion. The lower surface of the slide mold 120 is a molding surface for molding the upper end portion of the seal surface 27.

Finally, the partner mold 110 is pulled out forward. The partner mold 110 has an elongated recess 112 having an opening cross-section corresponding to the cross-sectional shape of the slide mold 120. The elongated recess 112 has a pair of left and right scraper surfaces 113 corresponding to the narrow space 45 of the lock hole 39 and the narrow portion 121 of the slide mold 120 in the rear portion. Each scraper surface 113 is a tapered surface in which the width of the opening of the elongated recess 112 becomes narrower toward the rear side, and constitutes the left and right side surfaces of the rear portion of the elongated recess 112.

When the slide mold 120 is pulled out as described above, a burr may be formed on the seal surface 27 at a position corresponding to the partner surface (parting surface) between the slide mold 120 and the partner mold 110. In the case of the second embodiment, even if a burr is formed on the seal surface 27 by pulling out the slide mold 120, after that, the scraper surfaces 113 of the elongated recess 112 can scrape off the burr on the seal surface 27 in the process of moving the partner mold 110 forward (see FIG. 13). Therefore, in the second embodiment, the burrs can be removed from the seal surface 27 by the movement of the partner mold 110, and the smooth and good seal surface 27 can be formed even without the continuous mold removal hole 34 on the upper side.

### Third Embodiment

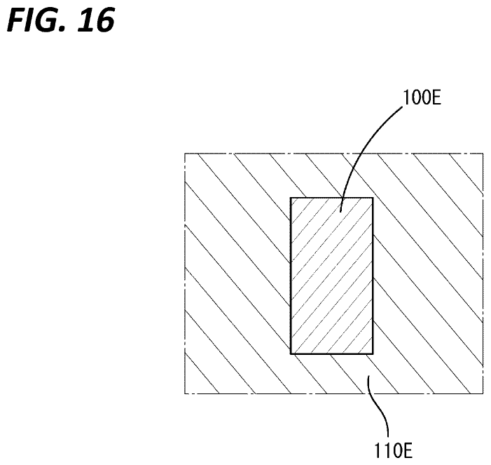

A third embodiment of the present disclosure is shown in FIG. 15. As shown in FIG. 15, a connector 10B according to the third embodiment is configured by adding a wire cover 46 to the connector 10 of the first embodiment. Although not shown in detail, the wire cover 46 is made of synthetic resin, has a cap shape, and is mounted on the connector housing 11 from behind. The wire cover 46 is disposed to cover a pulled-out portion of each wire 80 pulled out rearward through the cavity 19 of the corresponding cylindrical portion 25. The wire cover 46 includes a plurality of positioning portions 47 projecting forward from the cover portion. Each positioning portion 47 has a T-shaped or L-shaped cross-sectional shape corresponding to the opening cross-section of each continuous mold removal hole 34, and is disposed corresponding to the corresponding continuous mold removal hole 34. When the wire cover 46 is mounted on the connector housing 11, each positioning portion 47 is fitted and inserted into the corresponding continuous mold removal hole 34 from behind. Thus, the wire cover 46 is mounted on the connector housing 11 in a positioned state.

According to the third embodiment, since the wire cover 46 can be positioned using the continuous mold removal holes 34, it is not necessary to form a dedicated positioning hole or the like for positioning the wire cover 46 in the connector housing 11, and the configuration of the connector 10B can be simplified.

### Other Embodiments of the Present Disclosure

The first to third embodiments disclosed herein are intended to be considered as examples in all respects and not restrictive.

In the first to third embodiments, the step of the second mold removal hole has a shape extending in a direction orthogonal to the side edge of the first mold removal hole. Alternatively, according to another embodiment, the step of the second mold removal hole may have a shape extending while inclining in a direction intersecting the side edge of the first mold removal hole at an acute angle or an obtuse angle.

In the third embodiment, the wire cover having the positioning portion is mounted on the connector of the first embodiment. Alternatively, according to another embodiment, the wire cover having the positioning portion may be mounted on the connector of the second embodiment.

In the third embodiment, the positioning portion has a function of positioning the wire cover in the connector housing. On the other hand, according to another embodiment, the positioning portion may have a lock function of being locked to the coupling portion in addition to the above-described positioning function.

In the case of the third embodiment, the positioning portion is fitted into the continuous mold removal hole formed by the first mold removal hole and the second mold removal hole. On the other hand, according to another embodiment, the positioning portion may be fitted into one of the first mold removal hole and the second mold removal hole.

### LIST OF REFERENCE NUMERALS

10, 10A, 10B Connector
11 Connector housing
12 Terminal fitting
13 Retainer
14 Seal member
15 Housing body
16 Fitting tube portion
17 Coupling portion
18 Fitting space
19 Cavity
21 Lance
22 Connection portion
23 Barrel portion
24 Continuous tube portion
25 Cylindrical portion
26 Retainer insertion hole
27 Seal surface
28 Protrusion
29 Upper end surface
31 First mold removal hole
32 Second mold removal hole
33 Step
34 Continuous mold removal hole
35 Protection wall
36 Recess
37 Lock arm
38 Arm portion
39 Lock hole
41 Release operation portion
42 Slip prevention portion
43 Tube
44 Projecting wall
45 Narrow space
46 Wire cover
47 Positioning portion
80 Wire
85 Rubber plug
90 Partner connector
91 Partner connector housing
92 Partner terminal fitting
93 Hood
95 Lock portion
100, 100E Mold
101 Stepped recess
110, 110E Partner mold
111 Stepped protrusion
112 Elongated recess
113 Scraper surface
120 Slide mold
121 Narrow portion

1. A connector comprising:
a housing body having a seal surface on an outer peripheral surface facing an outer side;
a fitting tube portion surrounding the outer side of the housing body;
a coupling portion coupling the housing body and the fitting tube portion; and
a seal member mounted on the seal surface of the housing body,
wherein a fitting space is open between the housing body and the fitting tube portion and forward of the coupling portion, a hood of a partner connector is fitted into the fitting space, and the seal member is disposed in close contact with an inner peripheral surface of the hood and the seal surface of the housing body,
the housing body includes a protrusion protruding on the outer peripheral surface from a position forward of the seal surface into the fitting space, and
the coupling portion includes a first mold removal hole that is open at a position opposing a rear surface of the protrusion, and a second mold removal hole that is in communication with the first mold removal hole and, in a rear view of the coupling portion, is open side by side with the first mold removal hole and has a step extending in a direction intersecting a direction in which the first mold removal hole and the second mold removal hole are side by side.

2. The connector according to claim 1, wherein the first mold removal hole and the second mold removal hole each have a T-shape or an L-shape in the rear view of the coupling portion.

3. The connector according to claim 1,
wherein the housing body is provided with a cavity for accommodating a terminal fitting,
a pair of the first mold removal hole and the second mold removal hole is provided at left and right positions and at least one of upper and lower positions, with the cavity interposed therebetween in the rear view of the coupling portion,
the second mold removal hole disposed at at least one of the upper and lower positions includes the step extending in a left-right direction, and
the second mold removal hole is disposed at the left and right positions includes the step extending in an up-down direction.

4. The connector according to claim 1,
wherein a wire cover for covering a wire drawn out rearward from the housing body is mounted on the housing body, and
the wire cover has a positioning portion to be fitted into at least one of the first mold removal hole and the second mold removal hole.
